(19) United States
(12) Patent Application Publication
(10) Pub. No.: US 2013/0309081 A1
(43) Pub. Date: Nov. 21, 2013

(54) FLUID TURBINE WITH ROTOR UPWIND OF RINGED AIRFOIL

(71) Applicant: FLODESIGN WIND TURBINE CORP., Waltham, MA (US)

(72) Inventor: Søren Hjort, Silkeborg (DK)

(21) Appl. No.: 13/897,075

(22) Filed: May 17, 2013

Related U.S. Application Data
(60) Provisional application No. 61/648,362, filed on May 17, 2012.

(51) Int. Cl. F03D 1/04

(52) U.S. Cl. CPC F03D 1/04
USPC 415/211.2

(57) ABSTRACT

The present disclosure relates to a fluid turbine including a rotor and one or more ringed airfoil segments in fluid communication with a wake of the rotor. Each of the ringed airfoil segments includes a leading edge positioned co-planar with or downstream of the rotor plane as measured along the central axis. The ringed airfoil segments may include associated mixing elements. The fluid turbine may include a second ringed airfoil downstream of the one or more ringed airfoil segments.

### CROSS-REFERENCE TO RELATED APPLICATION

This application claims priority under 35 U.S.C. §119(e) to U.S. Provisional Patent Application Ser. No. 61/648,362, entitled “FLUID TURBINE WITH A ROTOR UPWIND OF A RINGED AIRFOIL” and filed on May 17, 2012, which is hereby incorporated by reference in its entirety.

### TECHNICAL FIELD

The present disclosure relates to fluid turbines of a particular structure, more specifically to a fluid turbine having a rotor in fluid communication with at least a portion of a ringed airfoil having a leading edge coplanar with, or downstream of, the rotor plane.

### BACKGROUND

Horizontal axis wind turbines typically include two to five rotor blades joined at a central hub, providing a rotor for capturing energy from a fluid stream. Generally speaking, a fluid turbine structure with an open rotor unshrouded design captures energy from a fluid stream that is smaller in diameter than the rotor. In an open rotor unshrouded fluid turbine, as fluid flows from the upstream side of the rotor to the downstream side, the fluid velocity remains constant as the flow passes through the rotor plane. Energy is extracted at the rotor resulting in a pressure drop on the downstream side of the rotor. The fluid directly downstream of the rotor is at sub-atmospheric pressure due to the energy extraction and the fluid directly upstream of the rotor is at greater than atmospheric pressure. The high pressure upstream of the rotor deflects some of the upstream air around the rotor. In other words, a portion of the fluid stream is diverted around the open rotor as if by an impediment. As it is diverted around the open rotor, the fluid stream expands, which is referred to as flow expansion at the rotor. Due to the flow expansion, the upstream area of the fluid flow is smaller than the area of the rotor.

In contrast, in a ducted or shrouded turbine, the upstream area of the fluid stream is larger than the area of the rotor. The duct or shroud contracts the fluid stream at the rotor plane and the fluid stream expands later after leaving the duct or shroud. The energy that may be harvested from the fluid is proportional to the upstream area where the fluid stream starts in a non-contracted state. In a conventional diffuser augmented turbine the diffuser surrounds the rotor such that the diffuser guides incoming fluid prior to the fluid interaction with the rotor, providing the largest unit-mass flow rate substantially proximal to the rotor plane. Expansion of the flow is delayed to the area downstream of the rotor, at the trailing edge of the duct or shroud. The upstream area of the fluid stream is larger than the area of the rotor plane due to the flow contraction at the duct or shroud.

A properly designed ducted or shrouded fluid turbine, delivers greater mass flow rate through the interior of the duct or shroud and, accordingly, through the rotor plane as compared with the mass flow rate through the rotor plane of an open rotor unshrouded fluid turbine. Improved performance of a fluid turbine including a rotor in fluid communication with a properly designed duct or shroud, in comparison to performance of a similar open rotor unshrouded fluid turbine, may be achieved due to a reduction in the production of tip vortices and due to the increased unit mass flow through the duct or shroud. However, the increased surface area and mass of the duct or shroud may cause unnecessary drag and loading that results in excessive forces on a support structure of the fluid turbine in high wind conditions.

### BRIEF DESCRIPTION

Embodiments include fluid turbine systems having a rotor defining a rotor plane and at least a portion of a ringed airfoil in fluid communication with a wake of the rotor. The portion of ringed airfoil has a leading edge that is co-planar with or downstream of the rotor. Some exemplary fluid turbines draw a higher energy secondary air flow that bypassed the rotor past a suction surface of the ringed airfoil to mix with a lower energy primary air flow that passed through the rotor. In some embodiments, positioning the rotor upstream of the leading edge of the ringed airfoil at least partially mitigates excessive load forces on support structures of the fluid turbine support structures in high fluid flow (e.g., high wind) conditions.

An embodiment includes a fluid turbine system with a rotor and one or more ringed airfoil segments. The rotor is configured to rotate about a central axis with the rotation of the rotor defining a rotor plane. The one or more ringed airfoil segments are disposed around the central axis and in fluid communication with a wake of the rotor. Each ringed airfoil segment has a leading edge that is co-planar with or downstream of the rotor plane as measured along the central axis.

In some embodiments, the one or more ringed airfoil segments form less than half a perimeter of a circle around the central axis. In some embodiments, the one or more ringed airfoil segments form more than half a perimeter of a circle around the central axis. In some embodiments, the one or more ringed airfoil segments fully encircle the central axis.

In some embodiments, the one or more ringed airfoil segments are configured to create a maximum in the unit mass flow rate downstream of the rotor plane.

In some embodiments, the rotor and each of the one or more ringed airfoil segments are configured to draw blade tip vortices from rotation of the rotor past a surface of the ringed airfoil segment facing toward the central axis. In some embodiments, the rotor and each of the ringed airfoil segments are configured to draw a secondary flow that bypassed the rotor past a surface of the ringed airfoil segment facing toward the central axis.

In some embodiments, at least some of the one or more ringed airfoil segments include at least one mixing element. The mixing element may include a mixing lobe. The mixing element may include a mixing slot.

In some embodiments, the fluid turbine also includes a second ringed airfoil downstream of the one or more ringed airfoil segments.

In some embodiments, a radius of the rotor plane is less than or equal to a distance from the central axis to an outer surface of the ringed airfoil segment for each ringed airfoil segment.

An embodiment includes a fluid turbine system with a rotor configured to rotate about a central axis defining a rotor plane and one or more ringed airfoil segments disposed around a central axis. The ringed airfoil segments are configured to create a maximum in the unit mass flow rate at a location downstream of the rotor plane. Each of the one or more ringed airfoil segments is configured to draw a flow that bypassed the rotor along a surface of the ringed airfoil segment facing toward the central axis.

### BRIEF DESCRIPTION OF THE DRAWINGS

The following is a brief description of the drawings, which are presented for the purposes of illustrating the disclosure set forth herein and not for the purposes of limiting the same. A more complete understanding of the components, processes, and apparatuses disclosed herein can be obtained by reference to the accompanying figures. These figures are intended to demonstrate the present disclosure and are not intended to show relative sizes and dimensions or to limit the scope of the disclosed embodiments. Further, like reference numbers refer to like elements throughout.

FIG. 1 is a front right perspective view of a fluid turbine, in accordance with an embodiment of the present disclosure.

FIG. 2 is a side cross-sectional view of the fluid turbine of FIG. 1.

FIG. 3 is a side cross-sectional view of a simulation of fluid flow through a fluid turbine in accordance with some embodiments.

FIG. 4 is a side cross-sectional view of a prior art fluid turbine.

FIG. 5 is a side cross-sectional view of flow through the fluid turbine of FIGS. 1 and 2, in accordance with some embodiments.

FIG. 6 is a side cross-sectional view of some forces on the ringed airfoil of the fluid turbine of FIGS. 1 and 2, in accordance with some embodiments.

FIG. 7 is a front right perspective view of a fluid turbine including an upper ringed airfoil section and a lower ringed airfoil section, in accordance with some embodiments.

FIG. 8 is a front right perspective view of a fluid turbine including a lower ringed airfoil section, in accordance with some embodiments.

FIG. 9 is a front right perspective view of a fluid turbine including mixing elements on a trailing portion of a ringed airfoil, in accordance with some embodiments.

FIG. 10 is a side cross-sectional view schematically depicting fluid flow through fluid turbine of FIG. 9.

FIG. 11 is a front right perspective view of a fluid turbine including mixing elements on a trailing portion of a ringed airfoil and a second ringed airfoil in the form of an ejector in fluid communication with the mixing elements, in accordance with some embodiments.

FIG. 12 is a side cross-sectional view schematically depicting fluid flow through the fluid turbine of FIG. 11.

FIG. 13 is a side cross-sectional view schematically depicting a fluid turbine having a rotor that is co-planar with a leading edge of a ringed airfoil, in accordance with some embodiments.

### DETAILED DESCRIPTION

The present disclosure relates to a fluid turbine including a rotor in combination with at least one substantially annular duct, or a portion of a substantially annular duct, with an airfoil cross section, (hereinafter, a “ringed airfoil”). The ringed airfoil, or portion of a ringed airfoil, is configured such that the leading edge of the ringed airfoil is co-planar with, or downstream of, the rotor plane as measured with respect to the central rotational axis. In some embodiments, load forces on the ringed airfoil or portion of a ringed airfoil are reduced when the turbine is configured with the rotor coplanar with, or upstream of, the inlet of the ringed airfoil.

In some embodiments, the ringed airfoil includes mixing elements to provide rapid mixing of wake vortices. In one embodiment, these mixing elements serve to assist combining a higher energy bypass flow that did not pass through the rotor plane with a lower energy primary fluid flow. In some embodiments, an ejector provides performance enhancements such as introducing additional high energy fluid flow and a low-pressure region, into the trailing edge vortices in the wake of a ringed airfoil, down-stream of the rotor. Various combinations of the ringed airfoil, or partial ringed airfoil, the mixing elements, and the ejector may provide increased power extraction and efficiency as compared with open rotor turbines without a ringed airfoil.

Some embodiments of fluid turbines including at least a portion of a ringed airfoil as described herein provide several advantages over a conventional open rotor unshrouded wind turbine. First, embodiments provide increased power extraction at the rotor from increased mass flow rate through the rotor plane and increased energy exchange in the turbine wake. In some embodiments, the ringed airfoil or partial ringed airfoil is configured to draw in a higher energy bypass fluid flow that does not pass through the rotor plane to mix with a lower energy primary fluid flow from which energy has been extracted by the rotor. The higher energy secondary flow energizes the primary flow resulting in an increased cumulative mass flow rate through the rotor plane, and increased power extraction. Additionally, by mixing the primary and secondary flows with the ringed airfoil or partial ringed airfoil the turbine wake is more efficiently mixed out allowing increased power extraction by those fluid turbines located downstream of the front fluid turbine (e.g., in a wind turbine farm environment with an array of wind turbines). Finally, mixing out the wake in accordance with the present invention aids in reducing the noise heard by an observer.

Some embodiments have multiple advantages over conventional shrouded fluid turbines. For example, in some embodiments, load forces on the ringed airfoil or portion of a ringed airfoil are reduced when the fluid turbine is configured with the rotor coplanar with, or upstream of, the inlet of the ringed airfoil as compared with conventional shrouded fluid turbines in which the rotor is positioned in the shroud. In many conventional shrouded fluid turbines, most of the weight of the rotor, the shroud, and the nacelle is positioned downstream of a central axis of a fluid turbine support tower resulting in a significant bending moment acting on the tower and the foundation supporting the tower due to the unbalanced weight. By locating the rotor and parts of the nacelle in upstream of the tower central axis, some of the weight of the ringed airfoil behind the tower central axis is at least partially offset by the weight of the rotor and the portion of the nacelle upstream of the tower central axis, thereby reducing the bending moment acting on the tower and the foundation.

Some embodiments also have benefits in manufacturing, assembly and design as compared with conventional shrouded turbines in which the rotor is located within the shroud. In some embodiments, because the rotor is not rotating within the ringed airfoil, the concentricity of the ringed airfoil is less critical than for conventional shrouded fluid turbines. A relatively small distance separates the rotor blade tips from the shroud surface in a conventional shrouded turbine, which means that that shroud cannot significantly change shape during use without risk of damage from blade tips hitting the shroud surface. In some embodiments, the ringed airfoil may be more free to deform (e.g., oval in shape) during maximum power extraction without increased risk of damage due to blade tip-ringed airfoil contact, which means freedom to use different designs, different materials and/or less structural material in manufacturing the ringed airfoil than would be required for a conventional shroud. Some embodiments may also provide benefits during assembly and erection (e.g., more rapid assembly) due to not having to position the rotor within the shroud and not having to finely adjust blade tip-shroud gaps. Finally, maintenance, such as blade replacement, is more easily accomplished when the rotor need not be carefully withdrawn from within the shroud before lowering the blades/generator to the ground.

Fluid turbines in accordance with the present disclosure may be used to extract energy from a variety of suitable fluids such as air (i.e., wind) or water. The aerodynamic principles of a wind turbine of the present invention also apply to hydrodynamic principles of a comparable water turbine and may be employed in conjunction with numerous fluid turbines that are at least in part shrouded.

Although specific terms are used in the following description, these terms are intended to refer only to particular structures in the drawings and are not intended to limit the scope of the present disclosure. It is to be understood that like numeric designations refer to components of like function.

The term “about” when used with a quantity includes the stated value and also has the meaning dictated by the context. For example, it includes at least the degree of error associated with the measurement of the particular quantity. When used in the context of a range, the term “about” should also be considered as disclosing the range defined by the absolute values of the two endpoints. For example, the range “from about 2 to about 4” also discloses the range “from 2 to 4.”

A turbine of the present disclosure provides an improved means of extracting power from a fluid stream. A substantially ringed airfoil is in fluid communication with a rotor having at least one mixing element combines bypass flow with flow that has passed through the rotor. A rotor is configured to extract more power in the region of the rotor plane that is in fluid communication with the mixing elements. This enhances the power extraction from the system by energizing the rotor wake where the most power is extracted.

Mixing elements include but are not limited to mixing lobes, mixing slots, vortex generators or ringed airfoil aerodynamic modifications that promote mixing and may be disposed at a variety of regions such as, but not limited to, the trailing edge of the ringed airfoil.

The term “rotor” is used herein to refer to any assembly in which one or more blades or blade segments are attached to a shaft and able to rotate, allowing for the generation or extraction of power or energy from fluid flow rotating the blade(s) or blade segments. Exemplary rotors may include any of a conventional propeller-like rotor, a rotor/stator assembly, a multi-segment propeller-like rotor, or any type of rotor understood by one skilled in the art that may be associated with the ringed airfoil of the present disclosure. As used herein, the term “blade” is not intended to be limiting in scope and shall be deemed to include all aspects of suitable blades, including those having multiple associated blade segments.

In one embodiment, the present disclosure relates to a fluid turbine comprising a rotor in combination with at least one substantially ringed airfoil (or a portion of a substantially ringed airfoil) in fluid communication with the circumference of the rotor plane, configured such that the leading edge of the ringed airfoil is coplanar with, or downstream of, the rotor plane. In some embodiments, of the ringed airfoil (or portion of the ringed airfoil) includes associated mixing elements that surround the exit of the ringed airfoil (or portion of the ringed airfoil). Other embodiments comprise associated mixing elements in fluid communication with a second ringed airfoil known as an ejector. In some embodiments, the mixing elements have the greatest effect on the perimeter of the exit region of the ringed airfoil.

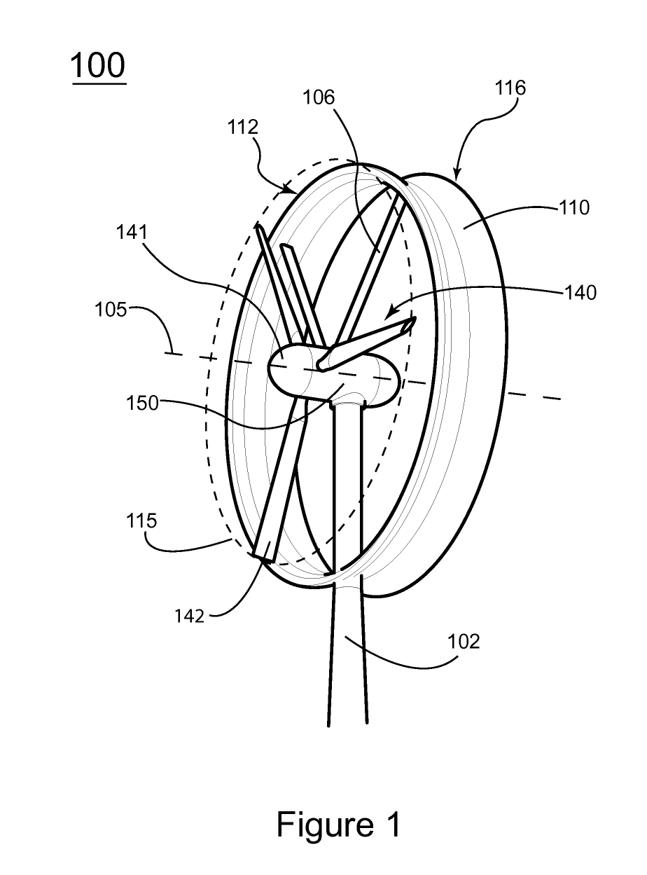

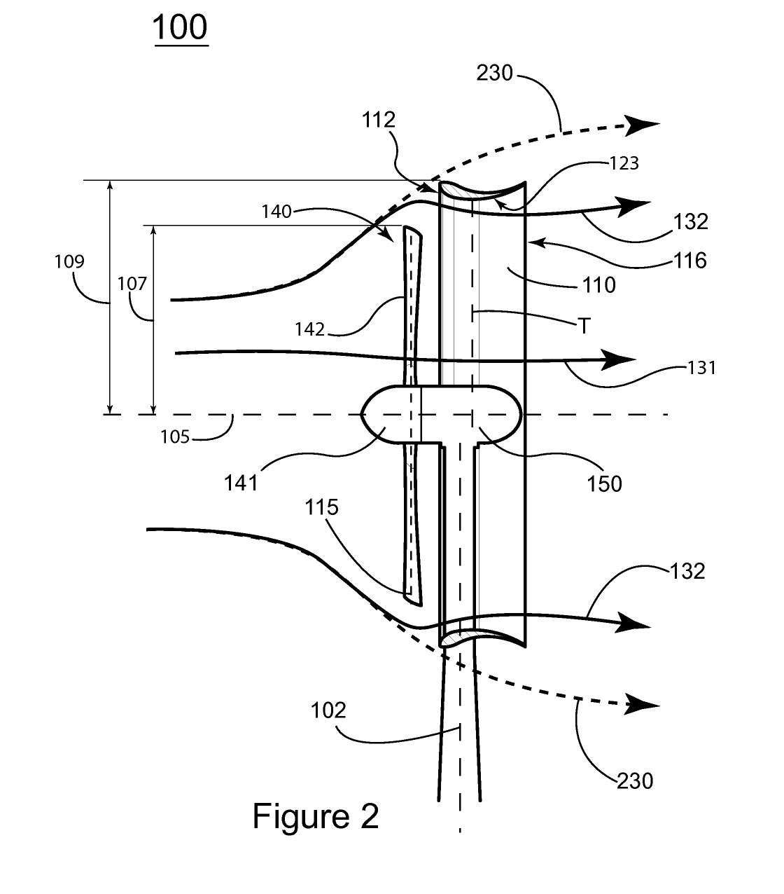

FIG. 1 is a right front perspective view of a fluid turbine 100, in accordance with an embodiment of the present disclosure. FIG. 2 is a side perspective view of the fluid turbine 100 of FIG. 1. The fluid turbine 100 includes a rotor 140 with rotor blades 142 that are joined at a central hub 141 and rotate about a central axis 105. The hub 141 is joined to a shaft (not shown) that is co-axial with the hub 141 and with the nacelle 150. In some embodiments, the nacelle 150 houses electrical generation equipment (not shown). The rotor plane is represented by the dotted line 115.

A ringed airfoil 110 is in fluid communication with the rotor plane 115 and is co-axial with the central axis 105. The ringed airfoil 110 includes a leading edge 112, which may also be identified as an inlet end or a front end, and a trailing edge 116, which may also be identified as a rear end, an exit or trailing edge. In some embodiments, support structures 106 are used to connect the nacelle 150 and the ringed airfoil 110. In some embodiments, each support structure 106 includes a proximal end engaged with the nacelle 150 and a distal end engaged with the ringed airfoil 110. The nacelle 150 and ringed airfoil 110 are supported by a tower structure 102.

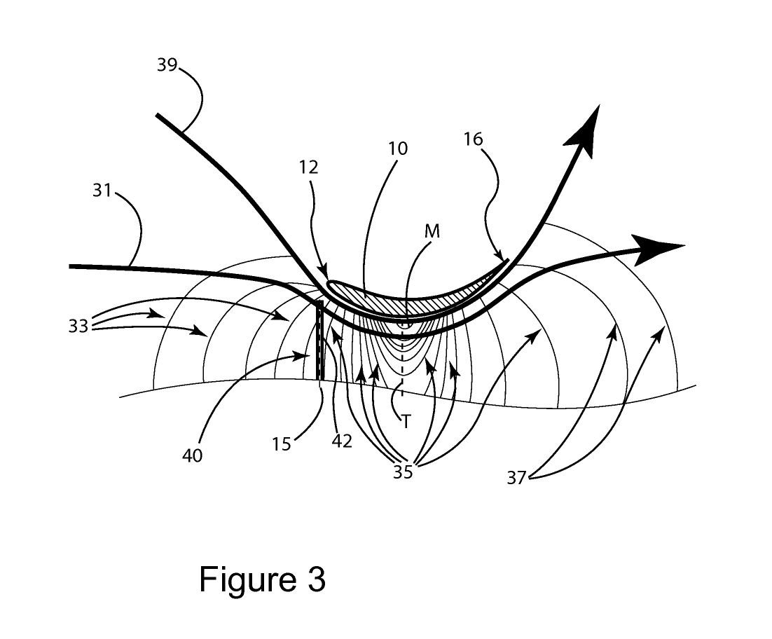

As shown in the side cross-sectional schematic view of FIG. 2, in some embodiments, the rotor 140 and the rotor plane 115 are located upstream of the leading edge 112 of the ringed airfoil 110. The rotor 140 and a portion of the nacelle 150 are upstream of a tower central axis 102. Generally speaking, the unit mass flow rate of fluid flow in the ringed airfoil 110 will have a maximum value in a plane T where the radial spacing between a suction surface 123 of the ringed airfoil and the nacelle 150 is the smallest. This may be referred to as the “throat” of the ringed airfoil. (See also discussion of maximum M in FIG. 3 below.) In fluid turbine 100, the rotor plane 115 is upstream of the plane of maximum unit mass flow rate T.

In some embodiments, the rotor has a diameter less than or equal to that of the ringed airfoil. For example, in FIG. 2, a radius 107 of the rotor plane 115 is smaller than a distance 109 from the central axis 105 to an outer surface of the ringed airfoil 110.

Generally speaking, a conventional open rotor unducted fluid turbine in a fluid stream is an impediment to the flow of the fluid stream. When the fluid stream encounters the open rotor, a portion of the stream enters the rotor plane and a portion of the stream is diverted around the impediment (e.g., beyond the tips of the rotor blades). For comparison, the fluid flow around a conventional open rotor unshrouded fluid turbine, (i.e., the flow that would occur if ringed airfoil 110 was not present) is schematically depicted by dotted line arrow(s) 230 in FIG. 2. However, in the presence of the ringed airfoil 110, some of the fluid stream that bypasses the rotor 140 (e.g., flows past beyond the tips of the blades) is drawn into the ringed airfoil 110, as depicted by the solid line arrow(s) 132. This bypass flow 132 has a higher energy than a primary flow 131 that lost energy as it passed through the rotor plane 115.

As depicted in FIG. 2, ringed airfoil 110 draws in two different types of fluid flows that combine within the ringed airfoil: the primary flow 131 whose energy was lowered to due extraction of energy at the rotor plane 115, and the higher energy secondary flow 132 that bypassed the rotor plane 115. The secondary flow 132 energizes the fluid turbine wake by mixing with the primary flow 131 within and downstream of the ringed airfoil 110. Further, the mixing of the primary flow 131 and the secondary flow 132 due to the ringed airfoil 110 may result in a more uniform flow velocity profile downstream of the fluid turbine 100, which would be desirable in configurations with additional downstream fluid turbines.

FIG. 3 schematically depicts a simulation of relative fluid velocities resulting from the interaction of an initially uniform incoming airflow with a rotor 40 and a ringed airfoil 10. A series of curved lines represent a contour map of relative velocity as the fluid flow passes through the ringed airfoil 10 with the velocity reaching a maximum value in region M within the ringed airfoil 10. The maximum value M of fluid velocity in the ringed airfoil 10 generally occurs in the “throat” T of the ringed airfoil 10 where the cross-sectional area of the passage between the ringed airfoil 10 and the nacelle (not shown) has a minimum. The throat T also corresponds to the plane with the maximum unit mass flow rate (i.e., most mass passing through a unit area in a unit time) within the ringed airfoil 10. Upstream lines 33 represent upstream fluid velocities that are relatively slower than that the fluid velocities inside the ringed airfoil 10, which are represented by lines 35. Lines 37, which follow the trailing edge 16 of the ringed airfoil 10, represent downstream velocities 37 slower than the velocities 35 in the ringed airfoil.

A primary fluid stream 31 is drawn through the rotor plane 15 by the low pressure associated with the increased velocities 35 in the ringed airfoil 10. Specifically, the lower pressure created within the ringed airfoil 10 draws flows from a larger cross-sectional area upstream, which is referred to as contraction. The rotor 40 extracts energy from the primary fluid stream 31 as is passes through the rotor 40 resulting in a lowered energy primary fluid stream 31 downstream of the rotor 40. The lower pressure created within the ringed airfoil 10 also draws in a secondary fluid stream 39 that bypasses the rotor 40 and the rotor plane 15. Because no energy is extracted from the secondary fluid stream 39 by the rotor 40, the secondary fluid stream 39 generally has a higher energy than the primary fluid stream 31 downstream of the rotor 40.

The configuration of the ringed airfoil 10 and the rotor 40 in the simulation shown in FIG. 3 are slightly different than the configuration of the ringed airfoil 110 and rotor 140 of fluid turbine 100 (e.g., rotor blades 40 of the simulated fluid turbine are shorter than rotor blades 140 of fluid turbine 100, the spacing between rotor plane 15 and leading edge 12 of the simulated fluid turbine is smaller than the spacing between rotor plane 115 and leading edge 112 of fluid turbine 100, the cross-sectional shape of ringed airfoil 10 of the simulated fluid turbine is slightly different than the cross-sectional shape of ringed airfoil 110 of fluid turbine 100). Nevertheless, like the simulated fluid turbine of FIG. 3, fluid turbine 100, and other similar fluid turbines also feature an analogous acceleration of fluid velocity within the ringed airfoil 110 and drawing a secondary higher energy fluid flow 132 through the ringed airfoil 110.

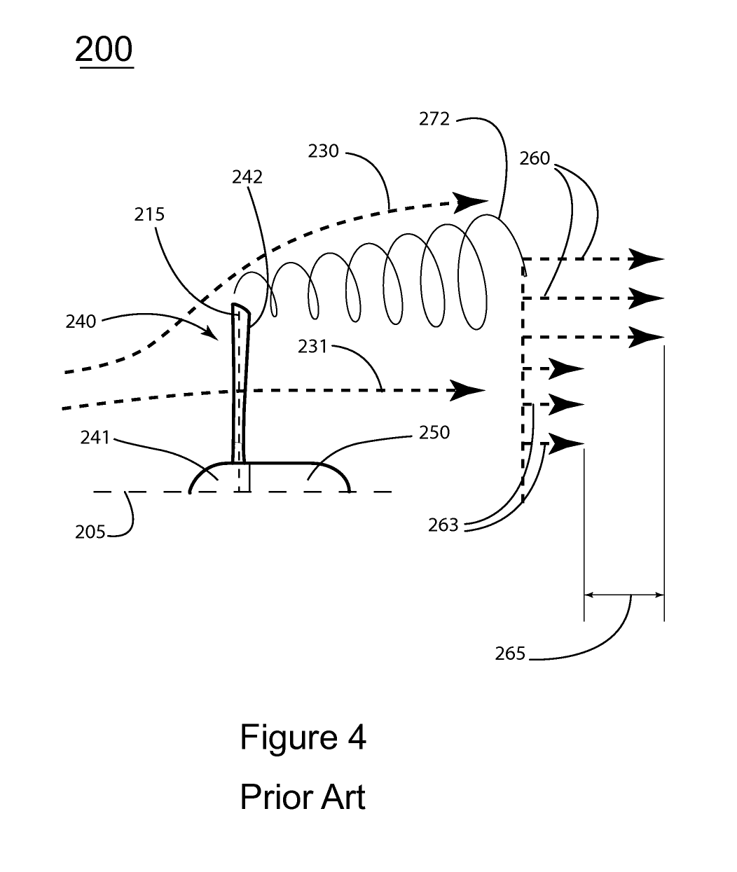

For comparison, FIG. 4 schematically depicts fluid flow interacting with a conventional open rotor wind turbine 200 and the nature of the downstream flow. A rotor 240 including rotor blades 242 is engaged with a hub 241. The hub 241 is, in turn, engaged with a rotating shaft (not shown) and electrical generation equipment (not shown), which may be housed in a nacelle 250. A first portion of the incoming fluid stream, represented by arrow 231 flows through the rotor plane 215 and a second portion of the incoming fluid stream, represented by arrow 230, is deflected around the rotor plane 215. In a conventional open rotor unshrouded fluid turbine design, trailing edge vortices are usually created at the trailing edges of rotor blades and are shed at the tips of the rotor blades (e.g., in the form of tip vortices 272). The resultant flow downstream of the rotor 240 includes a higher energy flow represented by arrows 260 that includes the propagating tip vortices 272, and the fluid stream from which energy has been extracted, otherwise known as lower energy flow, represented by arrows 263. The energy differential between the higher energy flow 260 and the lower energy flow 263 is represented by the length of difference arrow 265. A second fluid turbine located downstream from the conventional open rotor unshrouded fluid turbine 200 would experience an uneven flow field having a portion with the lower energy flow 263 and a portion with a higher energy flow 260.

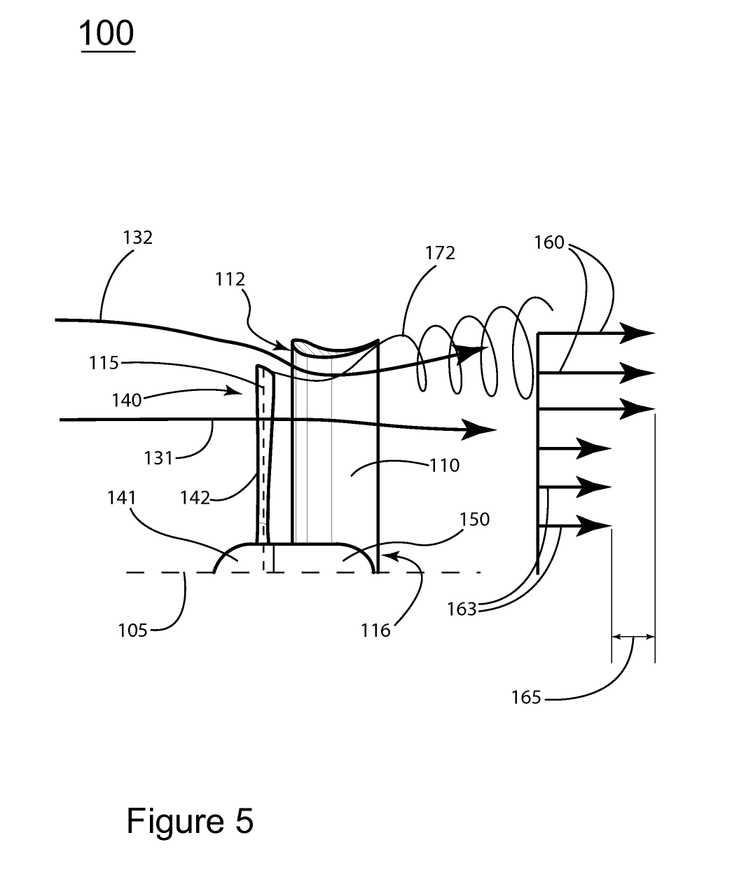

FIG. 5 schematically depicts a side cross-sectional view of fluid flow interacting with the fluid turbine 100, and the resulting downstream flow. As noted above, fluid turbine 100 includes a rotor 140 in fluid communication with a substantially ringed airfoil 110 having a leading edge 112 coplanar with or downstream of the rotor plane 115. A portion of the incoming fluid stream, which will be called the primary fluid stream and is represented by arrow 131 flows through the rotor plane 115. A secondary stream, represented by arrow 132 is drawn around the rotor plane 115 and through the ringed airfoil 110 by the suction side of the ringed airfoil. The suction produced in the ringed airfoil 110 also draws in the tip vortices 172 produced at the tips of the rotor blades 142. The resultant flow downstream of the rotor 140 and ringed airfoil 110 combination includes the higher energy portion of the stream including the propagating tip vortices and the secondary flow represented by arrows 160, and the lower energy portion of the fluid stream from which energy has been extracted, otherwise known as lower energy flow, represented by arrows 163. The tip vortices 172 that are drawn into the ringed airfoil 110 aid in mixing the higher energy secondary flow stream 132 that bypassed the rotor with the lower energy primary flow stream 131.

The energy differential between the higher energy secondary stream including propagating tip vortices 160 and the lower energy flow 163 is represented by the length of difference arrow 165. Another turbine located downstream from fluid turbine 100 would experience a fluid flow field having a portion with reduced energy content 163 and a portion with relatively higher energy content and propagating tip vortices 160. However, due the injection of energy by the secondary fluid stream 132 and due to mixing of the two fluid streams 132, 131 through the aerodynamic effect of the ringed airfoil 110, the resulting downstream energy differential as represented by 165, is smaller than the energy differential downstream of a similar open rotor fluid turbine without a ringed airfoil (see FIG. 4, energy differential 265). Normally, a more uniform incoming flow velocity profile is desirable for downwind fluid turbines. Presenting a more uniform flow profile to the next turbine in line (e.g., in a wind farm setting) allows the second turbine to see “cleaner” air from which more power can ultimately be extracted.

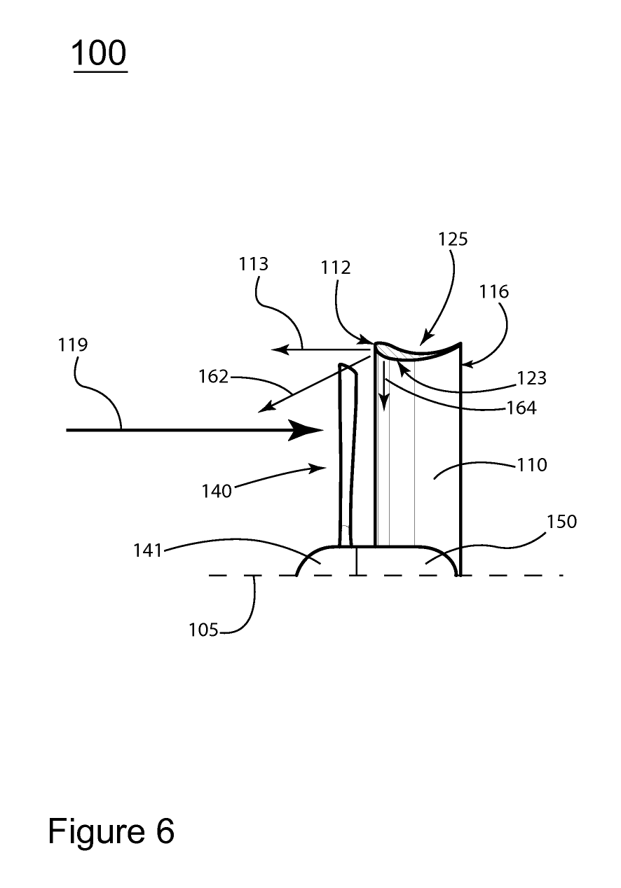

As shown in FIG. 6, in some embodiments, load forces in the downstream direction, are at least partially mitigated by a thrust force in the upstream direction, providing lower drag than that of a configuration having a rotor inside of the ringed airfoil. Arrow 119 represents load forces on rotor 140 and ringed airfoil 110. If the rotor were entirely within the ringed airfoil 110, the load forces on the turbine would be a result of the load forces on the rotor 140 and the load forces on the ringed airfoil 110. In contrast, in the depicted embodiment, flow 132 (see FIG. 5) flows over the ringed airfoil 110, but does not encounter the rotor. Flow over the ringed airfoil 110 creates a relatively higher pressure region on the outer surface 125, and a lower pressure region 123 resulting in a lift force 164. The camber of the airfoil and the angle of attack creates a forward force 113 in the direction from the trailing edge 116 toward the leading edge 112 of the ringed airfoil 110. The resultant force 162 is the result of the lift force 164 and the forward thrust force 113. The thrust force 113 at least partially counteracts load forces 119 on the ringed airfoil 110.

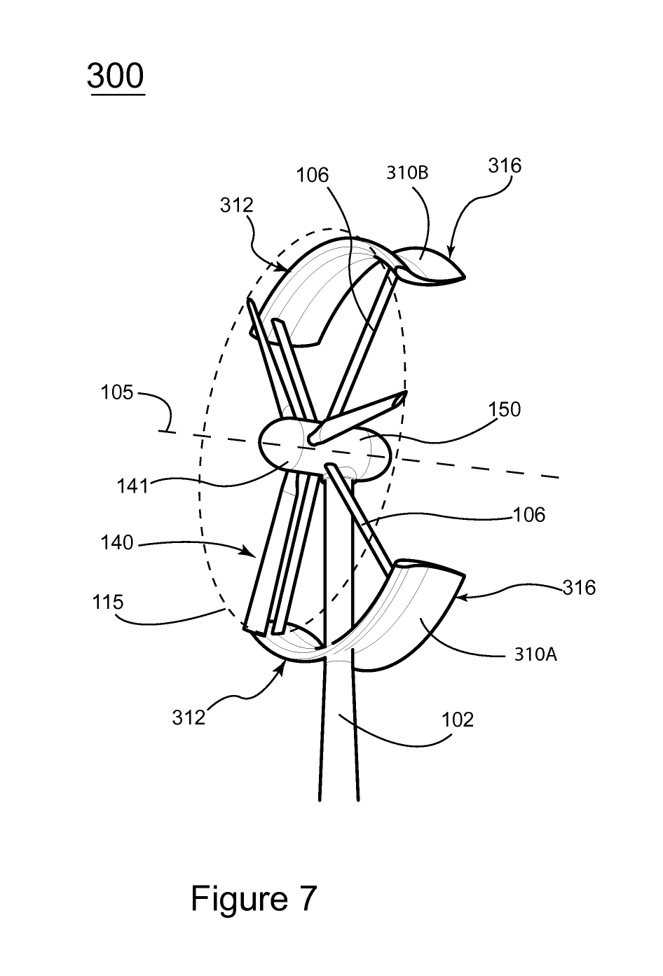

The ringed airfoil 110 of FIGS. 1, 2, 5 and 6 may be formed of one or more ringed airfoil segments that fully encircle the central axis 105. In some embodiments, a fluid turbine includes one or more ringed airfoil segments that only partially encircle the central axis, which may be referred to as a partially shrouded design. For example, FIG. 7 depicts another embodiment of a fluid turbine 300 that includes a lower region airfoil segment 310a and an upper region airfoil segment 310b in fluid communication with the wake of the rotor 140. Each airfoil segment 310a, 310b includes a leading edge 312, and a trailing edge 316. The leading edges of the airfoil segments 310a, 310b are downstream of the rotor plane 115. Employing ringed airfoil segments that only partially encircle the central axis can reduce the amount of material required for the ringed airfoil, and can yield other significant benefits. For example, a transient off axis flow (e.g., a wind gust) hitting a side portion of a ringed airfoil (e.g., the portion at a 3 o'clock position or a 9 o'clock position) can create forces that rapidly yaw the turbine in a new direction and create massive loads on the turbine tower and foundation. In practice, the inventors have found that, during use, off axis wind gusts are the most problematic as they spike the mechanical loads on the system (i.e., on the fluid turbine, tower and foundation), necessitating overdesigning the system to withstand the occasional off-axis load. By eliminating these side portions of the ringed airfoil (e.g., the portions at the 3 o'clock position and the 9 o'clock position), the transient off-axis flows merely flow through the wind turbine instead of creating massive spikes on the mechanical load on the system, lessening the maximum mechanical load the system will need to withstand.

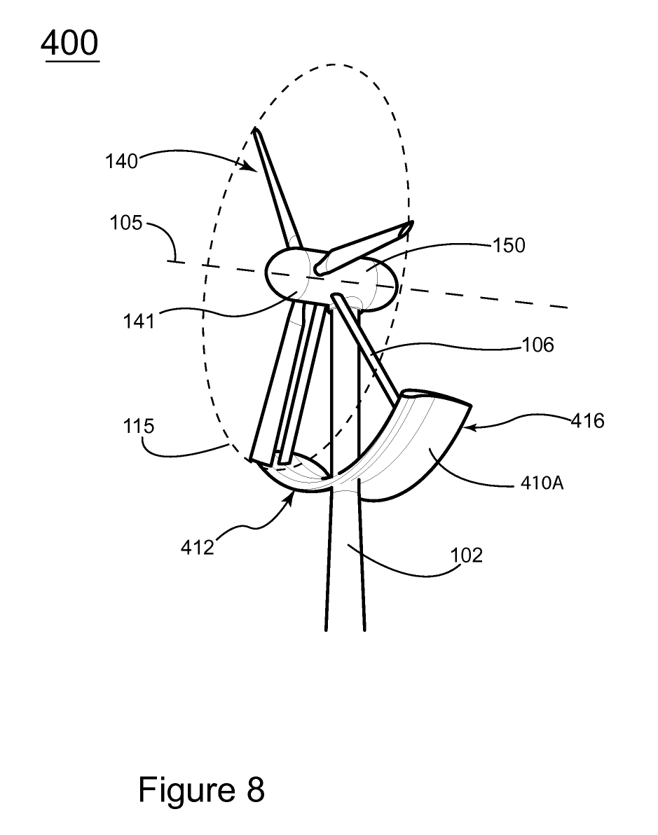

FIG. 8 depicts another embodiment of a partially shrouded fluid turbine 400 including an airfoil segment 410a in fluid communication with the wake of the rotor 140. The airfoil segment 410a includes leading edge 412 and trailing edge 416 with the leading edge 412 downstream of the rotor plane 115. The airfoil segment 410a at the lower region of the rotor plane 115 may be employed to compensate for wind shear when the fluid velocity in the upper region of the rotor plane 115 is greater than the fluid velocity in the lower region of the rotor plane 115.

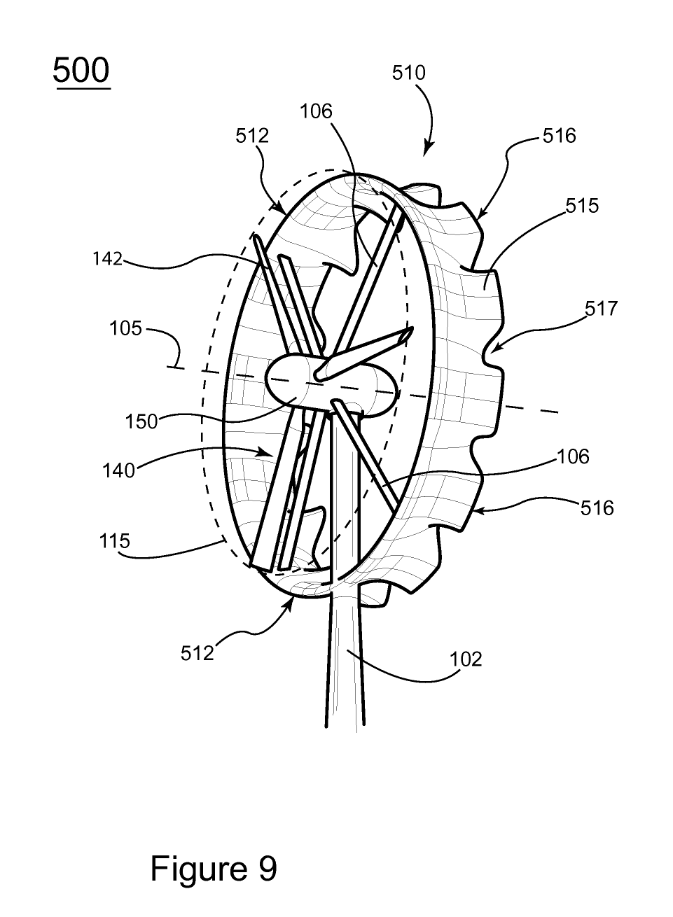

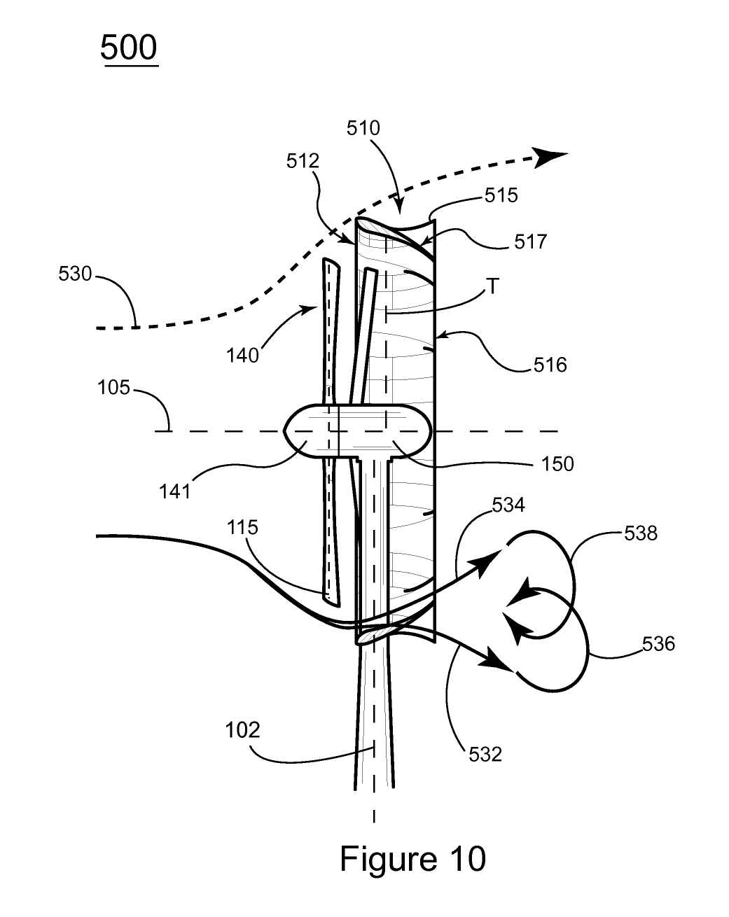

FIG. 9 is a right front perspective view of a fluid turbine 500 including a ringed airfoil 510 with mixing element(s), in accordance with another embodiment of the present disclosure. FIG. 10 is a side perspective view of fluid turbine 500. As shown in FIGS. 9 and 10 fluid turbine 500 includes a rotor 140 with rotor blades 142 that are joined at a central hub 141 and rotate about a central axis 105. The rotor plane defined by rotation of the rotor blades 142 about the central axis 105 is represented by the dotted line 115. A ringed airfoil 510 is in fluid communication with the rotor plane 115 and is co-axial with the central axis 105. Support structures 106 are engaged at the proximal end with the nacelle 150 and at the distal end with the ringed airfoil 510. The turbine and ringed airfoil are supported by a tower structure 102.

The ringed airfoil 510 includes a leading edge 512 and a trailing portion 516. The ringed airfoil 510 has the cross-sectional shape of an airfoil with a suction side (i.e., low pressure side, high velocity side) facing the central axis 105 and a pressure side (i.e., high pressure side, low velocity side) facing away from the central axis 105. The trailing portion 516 of the ringed airfoil 110 has mixing elements including outwardly turning mixing elements 515 that direct flow away from the central axis 105 and inwardly turning mixing elements 517 that direct flow toward the central axis 105. In some embodiments, the trailing portion 516 of the ringed airfoil 510 is shaped to form two different sets of mixing elements. The increased mixing due to the mixing elements 515, 517 may provide an increase in the unit mass flow rate within the ringed airfoil 510.

For comparison, the flow of a fluid stream around the open rotor in the absence of the ringed airfoil is depicted by dotted line arrow 530 in FIG. 10. The ringed airfoil 510 draws in a secondary higher energy flow that bypasses the rotor 140. The secondary higher energy flow is depicted by solid line arrow 532 showing flow along the surface of an outwardly turning mixing element 115 and by solid line arrow 534 showing flow along the surface of an inwardly turning mixing element 517. Interaction of flows 532 from the outwardly turning mixing elements and flows 534 from the inwardly turning mixing elements form mixing vortices including clockwise vortices 536 and counter clockwise vortices 538.

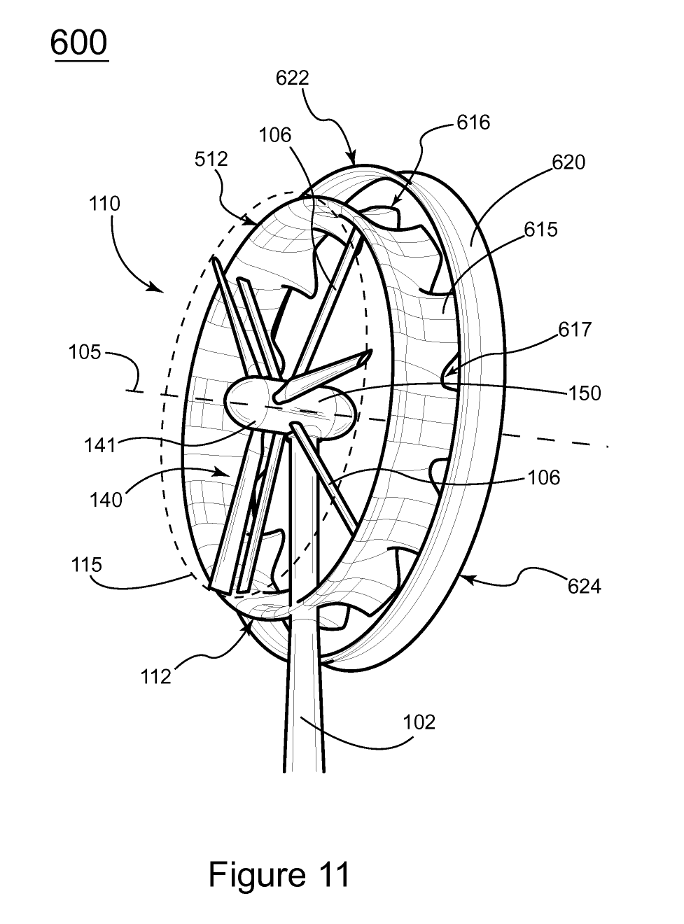

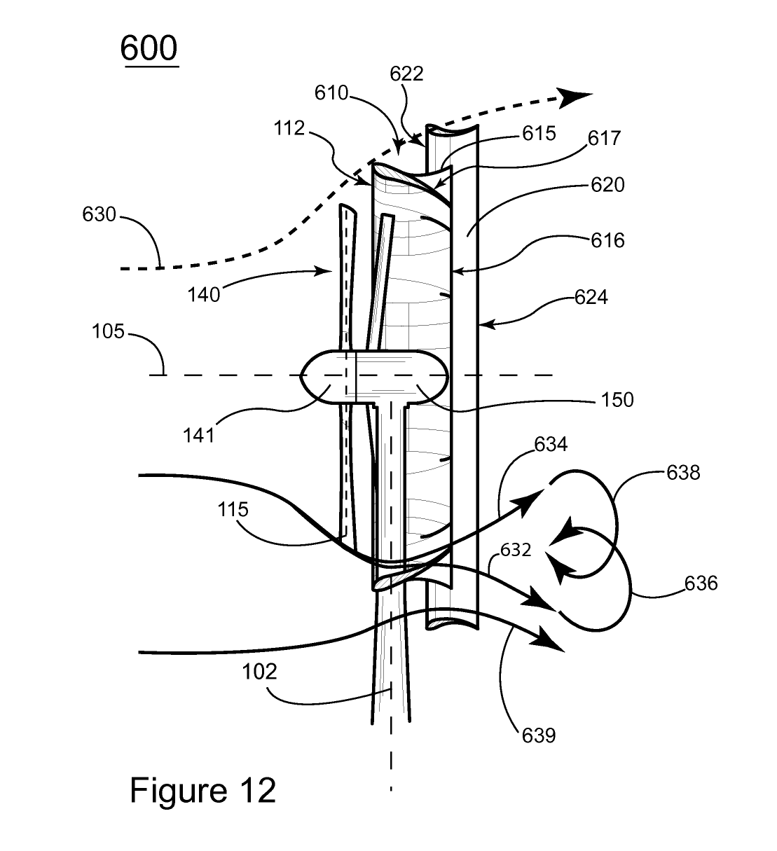

FIG. 11 is a front, right perspective view of a fluid turbine 600 including both a ringed airfoil 610 with mixing lobes 615, 617 and a downstream second ringed airfoil in the form of an ejector 620, in accordance with some embodiments. FIG. 12 is a side orthographic sectional view of fluid turbine 600. The fluid turbine 600 includes a ringed airfoil 610, and a rotor 140. The ringed airfoil 610 has a leading edge 612, also known as an inlet end or front end, and a trailing portion 616, also known as an exhaust end or rear end. The trailing portion 616 includes inwardly turning mixing elements 617, and outwardly turning mixing elements 615. The rotor 140 and hub 141, nacelle 150, ringed airfoil 610, and ejector 620 are concentric about a common axis 105 and are supported by a tower structure 102. Referring to FIG. 12, the turbine shroud 610 has the cross-sectional shape of an airfoil with a suction side (i.e. low pressure side) facing the common axis 105 and the pressure side facing away from the common axis 105.

A mixer-ejector pump is formed by the ejector shroud 620 in fluid communication with the ring of inwardly turning mixing elements 617 and outwardly turning mixing elements 615 on the turbine shroud 610. The mixing elements 615, 617 extend downstream toward or into an inlet 622 of the ejector shroud 620.

For comparison, the fluid stream flow over a conventional open rotor unshrouded fluid turbine is schematically depicted by dotted line arrow 630. The flow around the rotor 140 and through the ringed airfoil 610 is depicted by the solid line arrow 632 showing flow along a surface of an outwardly turning mixing element 615 and by the solid line arrow 634 showing flow along a surface of an inwardly turning mixing elements 617. The interaction of flows 632 and 634 creates mixing vortices including clockwise vortices 636 and counter-clockwise vortices 638. Additional high energy bypass flow is introduced to the turbine wake through the ejector 620, as shown depicted by arrow 639.

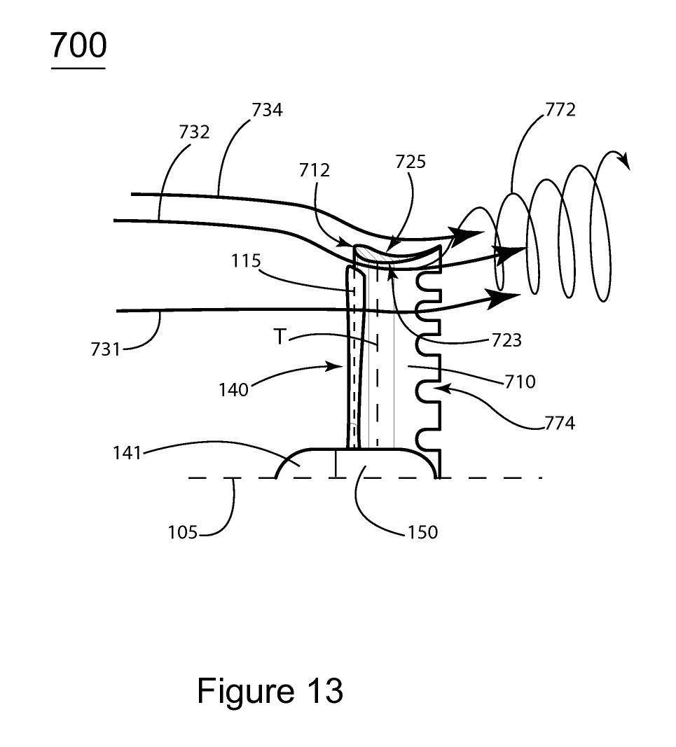

In some embodiments, the rotor plane of the fluid turbine is coplanar with the leading edge of the ringed airfoil. For example, FIG. 13 schematically depicts a fluid turbine 700 including a rotor 140, whose rotation about a central axis 105 defines a rotor plane 115. The fluid turbine 700 also includes a ringed airfoil 710 with a pressure surface 725 and a suction surface 723 that faces the central axis 105. At least part of a leading edge 712 of the ringed airfoil 710 is co-planar with the rotor plane 115. The ringed airfoil 710, which may include one or more airfoil segments, is configured to create a maximum in the unit mass flow rate at a throat T of the ringed airfoil 710, which is downstream of the rotor plane 115. The ringed airfoil is configured to draw a flow, which is referred to a higher energy secondary flow 732, that bypasses the rotor plane 115 and flows past the suction surface 723 of the ringed airfoil. The higher energy secondary flow 732 mixes with a lower energy primary flow 731 that passed through the rotor plane 115, forming an energized wake downstream of the fluid turbine 710. As shown, ringed airfoil 710 includes mixing elements in the form of slots 774 that aid in mixing the primary flow 731 and the secondary flow 732 with an additional flow 734 that passes around an outer pressure surface 725 of the ringed airfoil 710 and combine in mixing vortex 772.

One of ordinary skill in the art in view of the present disclosure would recognize that features in various embodiments may be combined or modified in various ways. For example, in some embodiments some or all of the ringed airfoil segments may include mixing elements. In some embodiments, the ringed airfoil may include multiple ringed airfoil segments with gaps between the segments. In some embodiments, the mixing elements take the form of mixing slots.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A fluid turbine system comprising:
a rotor configured to rotate about a central axis, the rotation of the rotor defining a rotor plane; and
one or more ringed airfoil segments disposed around the central axis in fluid communication with a wake of the rotor, each of the ringed airfoil segments including a leading edge co-planar with or downstream of the rotor plane as measured along the central axis.

2. The fluid turbine system of claim 1, wherein the one or more ringed airfoil segments form less than half a perimeter of a circle around the central axis.

3. The fluid turbine system of claim 1, wherein the one or more ringed airfoil segments form more than half a perimeter of a circle around the central axis.

4. The fluid turbine system of claim 1, wherein the one or more ringed airfoil segments fully encircle the central axis.

5. The fluid turbine system of claim 1, wherein the one or more ringed airfoil segments are configured to create a maximum in the unit mass flow rate downstream of the rotor plane.

6. The fluid turbine system of claim 1, wherein at least some of the one or more ringed airfoil segments include at least one mixing element.

7. The fluid turbine system of claim 6, wherein the at least one mixing element includes a mixing lobe.

8. The fluid turbine system of claim 6, wherein the at least one mixing element includes a mixing slot.

9. The fluid turbine system of claim 1, wherein the fluid turbine further includes a second ringed airfoil downstream of said one or more ringed airfoil segments.

10. The fluid turbine system of claim 1, wherein the rotor and each of the one or more ringed airfoil segments are configured to draw blade tip vortices from rotation of the rotor past a surface of the ringed airfoil segment facing toward the central axis.

11. The fluid turbine system of claim 1, wherein the rotor and each of the one or more ringed airfoil segments are configured to draw a secondary flow that bypassed the rotor past a surface of the ringed airfoil segment facing toward the central axis.

12. A fluid turbine system comprising:
a rotor configured to rotate about a central axis, the rotation of the rotor defining a rotor plane; and
one or more ringed airfoil segments disposed around the central axis and configured to create a maximum in the unit mass flow rate at a location downstream of the rotor plane, each of the one or more ringed airfoil segments configured to draw a flow that bypassed the rotor along a surface of the ringed airfoil segment facing toward the central axis.

13. The fluid turbine system of claim 12, wherein the rotor and each of the one or more ringed airfoil segments are configured to draw blade tip vortices from rotation of the rotor past the surface of the ringed airfoil segment facing toward the central axis.

14. The fluid turbine system of claim 12, wherein the one or more ringed airfoil segments form less than half a perimeter of a circle around the central axis.

15. The fluid turbine system of claim 12, wherein the one or more ringed airfoil segments form more than half a perimeter of a circle around the central axis.

16. The fluid turbine system of claim 12, wherein the one or more ringed airfoil segments fully encircle the central axis.

17. The fluid turbine system of claim 12, wherein at least some of the one or more ringed airfoil segments include at least one mixing element.

18. The fluid turbine system of claim 17, wherein the at least one mixing element includes a mixing lobe.

19. The fluid turbine system of claim 17, wherein the at least one mixing element includes a mixing slot.

20. The fluid turbine system of claim 12, wherein the fluid turbine further includes a second ringed airfoil downstream of said one or more ringed airfoil segments.

21. The fluid turbine system of claim 12, wherein, for each ringed airfoil segment, a radius of the rotor plane is less than or equal to a distance from the central axis to an outer surface of the ringed airfoil segment.
